(19) United States
(12) Patent Application Publication
(10) Pub. No.: US 2006/0120845 A1
(43) Pub. Date: Jun. 8, 2006

(54) Canoe loader

(76) Inventor: Randolph J. Moore, Wilmington, NC (US)

Correspondence Address: WILLIAM J. MASON;MACCORD MASON PLLC, POST OFFICE BOX 1489, WRIGHTSVILLE BEACH, NC, 28480, US

(21) Appl. No.: 11/230,396

(22) Filed: Sep. 20, 2005

Related U.S. Application Data
(60) Provisional application No. 60/630,073, filed on Nov. 22, 2004.

(51) Int. Cl. B60P 1/00

(52) U.S. Cl. 414/540

(57) ABSTRACT

An apparatus is described for use in loading a canoe or other watercraft into the bed of a truck having a hitch receiver located at the rear of the truck below the bed. The apparatus includes a first elongated support member having an inner end adapted for insertion into the hitch receiver and an outer end; a second elongated support member having an inner end pivotally attached adjacent the first member outer end, the second member being pivotal between a lowered position for loading of the canoe and a raised position for transport of the canoe; a watercraft support with canoe rollers attached adjacent the second member outer end; and a locking member to releasibly secure the second member relative to the first member. The first and second members may be telescoping to accommodate different size watercraft and truck beds.

This application claims the benefit of the filing date of U.S. patent application Ser. No. 60/630,073, filed Nov. 22, 2004.

### BACKGROUND OF THE INVENTION

(1) Field of the Invention

The present invention relates generally to a device to be attached to the back of a pickup truck for use in loading and unloading a canoe or other small watercraft into and from the bed of the pickup truck, and for securely transporting the watercraft.

(2) Description of the Prior Art

Transportation of a canoe in the bed of a pickup truck presents two problems. First, a canoe, due to its length, is cumbersome for one person to handle, requiring placement on one end of the canoe into the back of the pickup truck bed, and then pushing the canoe toward the front of the bed, which is unwieldy and may damage the canoe.

Second, the canoe is usually substantially longer than the pickup truck bed, creating the risk that the canoe will topple from the bed during transportation. As a result, the user must attempt to secure the canoe in the bed with ropes, bungee cord, and the like.

Thus, there is a need for a device that overcomes the difficulties encountered by one person in loading and unloading a small watercraft into and from the bed of a pickup truck and in securely transporting the watercraft once loaded, even when the length of the watercraft significantly exceeds the length of the pickup truck bed.

### SUMMARY OF THE INVENTION

The invention will be exemplified herein for use with a canoe, but will be understood to be equally applicable to use with other small watercraft, such as small outboard motor powered or manually powered boats, e.g., JON boats and kayaks. The invention is specifically designed for use with boats having a width up to the width of a typical pickup truck bed.

Generally, the canoe loader of the present invention is comprised of a horizontal first or main support member having an inner end adapted for insertion into a conventional trailer hitch receiver mounted at the back of the pickup truck below the level of the truck bed, and an outer end. The loader further includes a second support member or riser having an inner end pivotally attached adjacent to the outer end of the main support member and an outer end. A watercraft support is mounted at the outer end of the riser to support the lower surface of the canoe during loading, transport and unloading.

The main support member includes a hitch attachment at its inner end designed for insertion into a conventional trailer hitch receiver. The size and cross-sectional shape of the main member inner end will depend on the type of hitch receiver. Most pickup truck hitch receivers are of a square tubular construction and are designed to receiver a square insert that is 1.5 or 2 inch square.

The main support member may be telescoping, with a first section having an inner end to carry the hitch attachment and an outer end to receive a second section. The second section may be telescoping within the first section, with a pin or other releasable locking means being used to secure the sections at the desired telescoping distance. Preferably, the two sections are constructed of square tubing, oriented so that the sides of the tubing sections are vertical.

The second member or riser can be constructed of two telescoping sections that are also releasibly locked with a pin or other device. The second member can also be constructed of square tubing with vertical sides.

The inner end of the second member is pivotally attached to the outer end of the outer end of the first member so that the second member is pivotal between a lowered position for loading of the canoe and a raised position for transport of the canoe. Various means for attaching the second member to the first member can be used. For example, plates can be attached to either side of the outer end of the first member, with the inner end of the second member being inserted between and pivotally attached to the plates. Attachment can be by way of a pivot pin that is inserted through receiving holes in the two plates and the inner end of the second member.

In order to releasibly lock the second member at a desired angle relative to the first member, the plates are also provided with a plurality of matching locking holes positioned to be selectively aligned with a locking hole in the second member as the second member is pivoted. When the second member is pivoted to the desired angle in relation to the first member, a locking pin is inserted through the plate locking holes and the second member locking hole to secure the second member in the desired relationship relative to the first member.

The watercraft support mounted at the outer end of the second member has an upper surface that is adapted to receive the lower surface of the watercraft so that the watercraft rests on the support upper surface during loading, unloading and transport. Preferably, the upper surface is comprised of a pair of rollers having a common axis transverse to the longitudinal axis of the second member. The upper surfaces of the rollers being in a common horizontal plane, or the rollers may be independently adjustable, e.g., by longitudinally adjusting the roller mount, to compensate for differences in the lower surface of the canoe. Thus, as the watercraft is loaded or unloaded the lower surface of the watercraft rolls on the rollers substantially reducing friction and facilitating loading and unloading by a single individual.

The rollers are attached to the outer end of the second member with roller mounts that may be attached to the sides of the second member outer end. Eyebolts may be used to attach the roller mounts. These eyebolts may also be used to secure a holding strap, bungee cord or the like, collectively referred to herein as tie-down straps, around the loaded watercraft. The eyebolts and other bolts securing the roller mount may be inserted through elongated slots to longitudinally adjust the position of the roller mount.

In use, the inner end of the first member is inserted into the truck hitch receiver, positioning the first member horizontally. The riser is pivoted to its lowered position at or slightly below horizontal and locked in position with a locking pin. The leading end of the canoe is then centered on the rollers, the rear end of the canoe is then picked up slightly and the canoe is pushed on the rollers into the bed of the truck.

The riser is then pivoted to its raised position and locked in place with the locking pin. In the raised position, the watercraft support is at or above the plane of the pickup truck bed. A hold down strap, bungee cord or the like is then drawn around the canoe and attached to the eyebolts to secure the canoe against the rollers.

### BRIEF DESCRIPTION OF THE DRAWINGS

FIG. 1 is a side view of the loader with the riser in the raised position.

FIG. 2 is a side view of the loader with the riser in the lowered position.

FIG. 3 is a top view of the distal end of the riser showing positioning of the rollers.

FIG. 4 is a side view of a canoe being loaded into the bed of a pickup truck.

FIG. 5 is a side view of a canoe loaded into the bed of a pickup truck and supported by the apparatus of the present invention.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

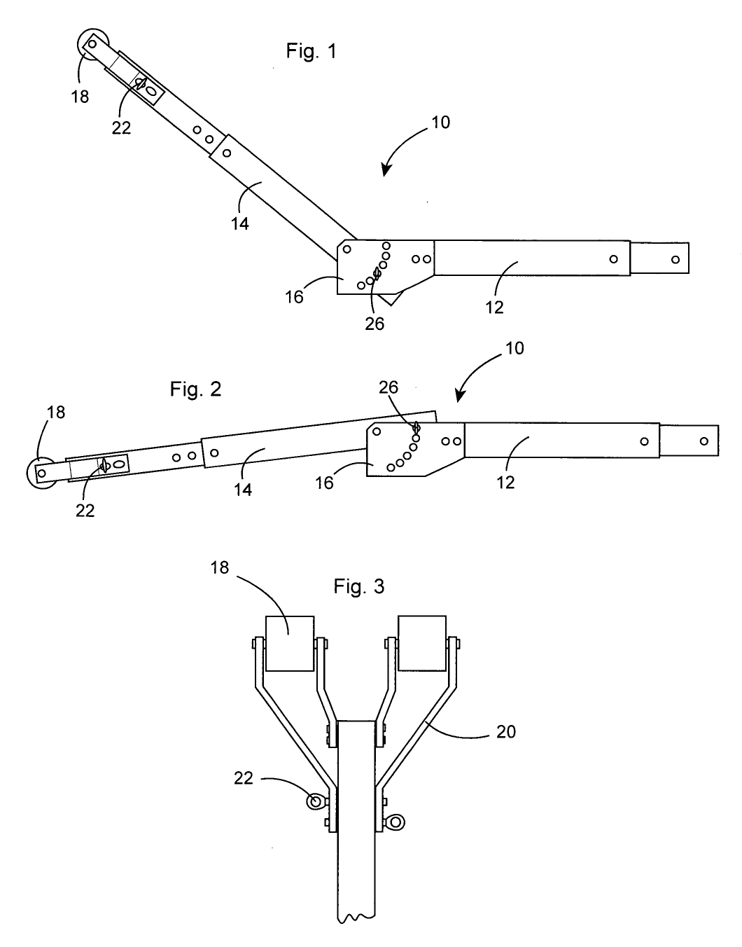

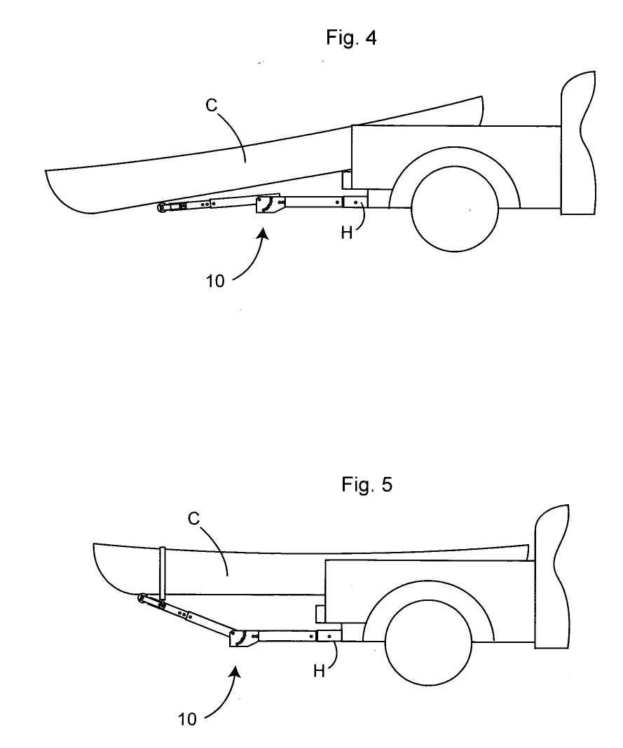

As best illustrated in FIGS. 1 and 2, loader, generally 10, is comprised of horizontal first or main support 12 having a front or inner end adapted for insertion into a conventional trailer hitch receiver H, and a rear end. As illustrated, support 12 is a telescoping support to accommodate different truck and canoe dimensions. The different sizes of the inner and outer sections of support 12 can also be used to accommodate different size trailer hitches, e.g. 1.5 or 2 inch square trailer hitches.

Loader 10 further includes second member or riser 14 having an inner end pivotally attached adjacent the outer end of main support 12 with locator plates 16, and an outer end. As shown, riser 14 is also of a telescoping construction permitting the canoe to be supported at different heights depending on the size and position of the truck bed. The outer end of riser 14 includes spaced rollers 18 adapted to support the lower surface of the canoe during loading, transport and unloading. Rollers 18 are spaced on either side of riser 14 equidistant from the longitudinal axis of riser 14 on supports 20, which are attached to riser 14 with eyebolts 22. Eyebolts 22 are also used to attach tie-down strap 24, illustrated in FIG. 5.

In use, riser 14 is moved to its lowered position as shown in FIGS. 2 and 4 in which riser 14 is at an angle at or below horizontal. The leading end of the canoe C is then centered on rollers 18. The rear end of the canoe is then picked up slightly and canoe C is pushed on rollers 18 into the bed of the truck. Riser 14 is then pivoted to the raised position shown in FIGS. 1 and 5 in which riser 14 is at an angle above horizontal and locked in place with locking pin 26. Tie-down strap 24 is then drawn around the canoe C with the ends attached to eyebolts 24 to secure canoe C against rollers 18. Canoe C is unloaded by disconnecting tie-down strap 24, lifting the front end of canoe C, and rolling canoe C out of the truck bed.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. An apparatus for use in loading a watercraft into the bed of a truck having a hitch receiver comprising:
a) a first elongated support member having an inner end adapted for insertion into said hitch receiver and an outer end;
b) a second elongated support member having an inner end pivotally attached adjacent said first member outer end; and
c) a watercraft support attached adjacent said second member outer end.

2. The apparatus of claim 1, wherein said first member is telescoping.

3. The apparatus of claim 1, wherein said second member is telescoping.

4. The apparatus of claim 1, wherein said second member is pivotal between a lowered position and a raised position.

5. The apparatus of claim 1, wherein said watercraft support includes rollers positioned to engage said watercraft.

7. The apparatus of claim 1, further including a locking member to releasibly secure said second member relative to said first member.

8. An apparatus for use in loading a watercraft into the bed of a truck having a hitch receiver comprising:
a) a first elongated support member having an inner end adapted for insertion into said hitch receiver and an outer end;
b) a second elongated support member having an inner end pivotally attached adjacent said first member outer end, said second member being pivotal between a lowered position and a raised position;
c) a watercraft support attached adjacent said second member outer end; and
d) a locking member to releasibly secure said second member relative to the first member.

9. The apparatus of claim 8, wherein said first member is horizontal when inserted into said hitch receiver.

10. The apparatus of claim 8, wherein said second support member includes a longitudinal axis and said watercraft support includes a roller on either side of said axis.

11. The apparatus of claim 8, further including a tie-down strap and latching members adjacent said second member outer end.

12. The apparatus of claim 8, wherein the outer end of said first member includes parallel outer sides, said apparatus further including spaced parallel locator plates with locking holes attached to said outer sides, said second member being pivotally attached to said locator plates.

13. The apparatus of claim 8, wherein said watercraft support is approximately in a horizontal plane with the bed of the truck when said second member is in the raised position.

14. The apparatus of claim 8, wherein said second member extend at an angle at or below horizontal when in the lowered position.

15. An apparatus for use in loading a watercraft into the bed of a truck having a hitch receiver comprising:
a) a first elongated support member having an inner end adapted for insertion into said hitch receiver and an outer end with parallel sides;
b) a second elongated support member pivotal between a lowered position and a raised position, said second member having an inner end and an outer end;
c) a watercraft support attached adjacent said second member outer end;
d) spaced parallel locator plates with locking holes attached to said outer sides, said second member inner end being pivotally attached to said locator plates.
e) a locking pin insertable through selected holes in said support plates and said second member to releasibly secure said second member in relation to said first member.

16. The apparatus of claim 15, wherein said first and second members are telescoping.

17. The apparatus of claim 15, wherein said first and second members have a rectangular cross-section.

18. The apparatus of claim 15, wherein said watercraft support includes a pair of spaced supporting rollers.

19. The apparatus of claim 15, further including eyebolts adjacent said second member outer end and a tie-down strap attachable to said eyebolts.

20. The apparatus of claim 15, wherein said second member has vertical sides, said watercraft support including roller supports extending outwardly from said second member sides and rollers attached to said supports, said rollers having upper surfaces in a common horizontal plane.
